(19) United States
(12) Patent Application Publication
(10) Pub. No.: US 2020/0377087 A1
(43) Pub. Date: Dec. 3, 2020

(54) LANE KEEP CONTROL OF AUTONOMOUS VEHICLE

(71) Applicant: SF Motors, Inc., Santa Clara, CA (US)

(72) Inventors: Kailiang Chen, Santa Clara, CA (US); Jhenghao Chen, Santa Clara, CA (US); Fan Wang, Santa Clara, CA (US); Yifan Tang, Santa Clara, CA (US)

(73) Assignee: SF Motors, Inc., Santa Clara, CA (US)

(21) Appl. No.: 16/423,902

(22) Filed: May 28, 2019

(51) Int. Cl. B60W 30/12; G06K 9/00; G05D 1/02; B60W 40/072

(52) U.S. Cl. CPC B60W 30/12; G06K 9/00798; G05D 2201/0213; B60W 40/072; G05D 1/0246

(57) ABSTRACT

An autonomous vehicle (AV) is automatically navigated within a a driving lane. Lane line data is received from one or more sensors, such as one or more cameras. A first parametric curve can be matched to a location of a first lane line detected from the lane line data. A second parametric curve can be matched to a location of a second lane line detected from the lane line data. A center parametric curve can be then generated in the center of the first parametric curve and the second parametric curve. The center parametric curve is then sampled to generate a discrete vector of trajectory points along the center parametric curve. The AV is then navigated along the road based on the trajectory points.

### BACKGROUND

Autonomous driving technology is growing rapidly with many features implemented in autonomous vehicles. One of the fundamental functions of the AV is the ability to navigate along a road automatically. Keeping the AV in a lane can be challenging in terms planning, safety, and accuracy of a navigation path.

### SUMMARY

The present technology, roughly described, includes systems and methods for keeping an autonomous vehicle (AV) in a driving lane. Lane line data is received from one or more sensors, such as one or more cameras. The first lane line and the second lane line represent boundaries of the driving lane being navigated by the AV, and the lane line data include images of the lanes on the road currently being traveled. A first parametric curve can be matched to a location of a first lane line detected from the lane line data. A second parametric curve can be matched to a location of a second lane line detected from the lane line data. A center parametric curve can be then generated, for example in the center of, the first parametric curve and the second parametric curve. The center parametric curve is then sampled to generate a discrete vector of trajectory points along the center parametric curve. The AV is then navigated along the road based on the trajectory points.

In some instances, the system includes a data processing system including one or more processors, a memory, a planning module, and a control module. The data processing system can be configured to generate a first parametric curve to match a first lane line and a second parametric curve to match a second lane line. The first lane line and the second lane line represent boundaries of a lane. The data processing system can determine, based on the first parametric curve and the second parametric curve, a center parametric curve. The center parametric curve can extend into the center between the first lane line and the second lane line. The data processing system can generate, based on the center parametric curve, a discrete vector of trajectory points. The trajectory points can be located along the center parametric curve. The data processing system can generate, based on the discrete vector of the trajectory points, at least one action to navigate the AV along a set of the trajectory points.

In some instances, the present technology is directed to a method for keeping an AV in a driving lane. The method may include generating, by a data processing system, a first parametric curve to match a first lane line and a second parametric curve to match a second lane line. The first lane line and the second lane line can represent boundaries of a lane. The method may further include determining, by the data processing system and based on the first parametric curve and the second parametric curve, a center parametric curve that extends into the center between the first lane line and the second lane line. The method may further include generating, by the data processing system and based on the center parametric curve, a discrete vector of trajectory points. The trajectory points are located along the center parametric curve. The method may include generating, by the data processing system and based on the discrete vector of the trajectory points, at least one action to navigate the AV along a set of the trajectory points.

In some instances, a non-transitory computer readable storage medium includes embodied thereon a program, wherein the program is executable by a processor to perform a method for keeping an AV in a driving lane. The method may include generating a first parametric curve to match a first lane line and generate a second parametric curve to match a second lane line. The first lane line and the second lane line represent boundaries of a lane. The method may further include determining, based on the first parametric curve and the second parametric curve, a center parametric curve. The center parametric curve extends in center between the first lane line and the second lane line. The method may further include generating, based on the center parametric curve, a discrete vector of trajectory points. The trajectory points are located along the center parametric curve. The method may further include generating, based on the discrete vector of the trajectory points, at least one action to navigate the AV along a set of the trajectory points.

Additional objects, advantages, and novel features of the examples will be set forth in part in the description which follows, and in part will become apparent to those skilled in the art upon examination of the following description and the accompanying drawings or can be learned by production or operation of the examples. The objects and advantages of the concepts can be realized and attained by means of the methodologies, instrumentalities and combinations particularly pointed out in the appended claims.

### BRIEF DESCRIPTION OF FIGURES

FIG. 1 is a block diagram illustrating an AV, according to an example embodiment.

FIG. 2 is a block diagram 200 of a data processing system of an AV, according to an example embodiment.

FIG. 3 is a block diagram of system logic 300 for keeping an AV in a driving lane, according to an example embodiment.

FIG. 4 illustrates a method 400 for keeping an AV in a driving lane, in accordance with an example embodiment.

FIG. 5 illustrates a method for generating lane parametric curves, according to an example embodiment.

FIG. 6 illustrates a method for generating center line vector data, according to an example embodiment.

FIG. 7 illustrates a method for generating actions to keep an AV in a current driving lane, according to an example embodiment.

FIGS. 8-11 illustrate an environment within which a system and method for keeping an AV in a driving lane can be implemented, in accordance with some example embodiments.

FIG. 12 is a block diagram of a computing environment for implementing a system for keeping an AV in a driving lane can be implemented, according to an example embodiment.

### DETAILED DESCRIPTION

The present technology, roughly described, includes systems and methods for keeping an autonomous vehicle (AV) in a driving lane. Lane line data is received from one or more sensors, such as one or more cameras. The first lane line and the second lane line represent boundaries of the driving lane being navigated by the AV, and the lane line data include images of the lanes on the road currently being traveled. A first parametric curve can be matched to a location of a first lane line detected from the lane line data. A second parametric curve can be matched to a location of a second lane line detected from the lane line data. A center parametric curve can be then generated, for example in the center of, the first parametric curve and the second parametric curve. The center parametric curve is then sampled to generate a discrete vector of trajectory points along the center parametric curve. The AV is then navigated along the road based on the trajectory points.

The technical problem addressed by the systems and methods of the presented disclosure involves optimizing navigation of an AV to stay within a current lane. Most existing AV systems utilize only a single set of pipelines between different modules of AVs to handle different lane line curvature. This requires substantial processing strength and resources in vehicle modeling and tuning, which will lead to a lack of computational efficiency of controllers of the previous AVs. Hence, most current AV systems do minimal processing to navigate in a current lane, as there is no efficient way to perform detailed analysis in real time for navigating a lane.

The presently described AV system solves the technical problem by efficiently collecting large amounts of data and efficiently processing the data to determine a path along which an AV should navigate. The processing includes collecting detailed perception data, generating desired path data from the detailed perception data, sampling the desired path data, and navigating the AV based on the sampled data. In some instances, parametric curves are used to represent the lane lines through the planning module and converted into a vector of trajectory points only in the control module prior to performing a lateral control calculation. The main advantage of this approach is the ability to change the planning algorithm while keeping the parametric curves in the same form as they are passed to a control module. The tuning of the lateral control is coupled with the process of discretization of the parametric curve to the vector of trajectory points. The process of the discretization of the parametric curve can be kept inside the control module and decoupled with any changes in the planning module. Thus, the control module may not only be used for planning task of keeping the AV in a driving lane, but also for other planning tasks, such as auto parking, lane change, and so forth.

In AV systems of the prior art, a steering mechanism may experience latency between the time a steering command is issued and the time at which the AV wheels are turned. Moreover, different vehicles may have different steering wheel latencies that could create unstable and unpredicted behaviors to the AV systems. Unlike many control algorithms, the present technology accounts for the latency of steering the AV, for example by a control module, to create a real time response, especially for high speed scenarios.

During operations, AVs are required to follow a path. The path tracking may utilize geometry of lane lines. Keeping AVs in a driving lane can be performed substantially by the lateral controller and planning related to the lateral controller. The task of following the path is performed by planning and control of the AV. The planning can be roughly separated into two layers, namely global navigation layer and local path following layer. The local path control can be separated into two portions: a lateral control and longitudinal control.

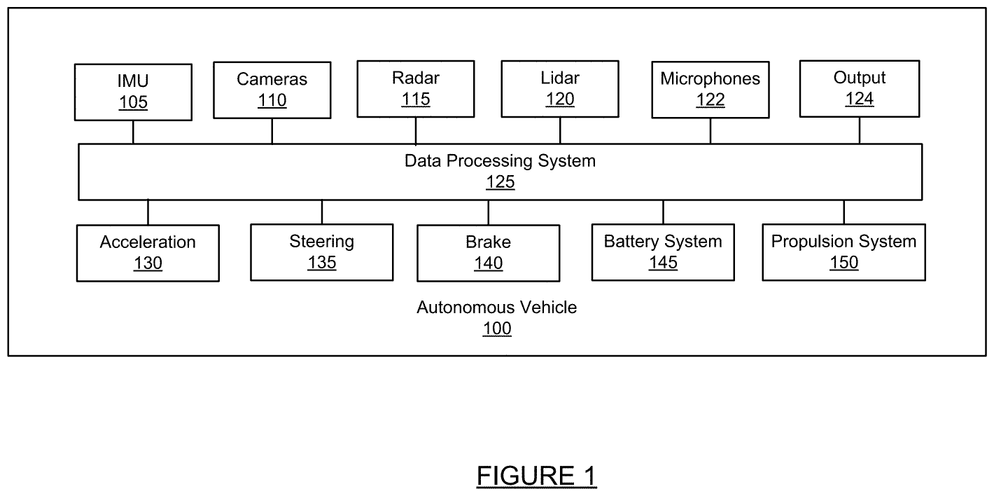

FIG. 1 is a block diagram illustrating an AV 100, according to an example embodiment. The AV 100 can include a data processing system 125 in communication with an inertia measurement unit (IMU) 105, cameras 110, radar 115, lidar 120, microphones 122, and output 124. Data processing system 125 may also communicate with acceleration 130, steering 135, brake 140, battery system 145, and propulsion system 150. The data processing system 125 and the components it communicates with are intended to be exemplary for purposes of this discussion. It is not intended to be limiting, and additional elements of the AV can be implemented in a system of the present technology, as will be understood by those of ordinary skill in the art.

IMU 105 may track and measure the AV acceleration, yaw rate, and other measurements and provide that data to data processing system 125 as well as other components of AV 100.

Cameras 110, radar 115, lidar 120, and microphones 122 may form all or part of a perception module of the AV 100. The AV 100 may include one or more cameras 110 to capture visual data inside and outside of the AV 100. Multiple cameras, including one or more HD cameras, can be installed on the outside of the AV 100. For example, cameras on the outside of the AV 100 may capture a forward-facing view, a rear-facing view, and, optionally, other views. Images from the cameras can be processed to detect objects such as streetlights, stop signs, lines or borders of one or more lanes of a road, and other aspects of the environment for which an image can be used to ascertain the nature of an object. In order to detect objects, pixels of images can be processed to recognize objects, singular images, and series of images. The processing can be performed with image and video detection algorithms, machine learning models, computer vision techniques, deep learning techniques, and other algorithms which operate to detect particular objects of interest, as well as other object detection techniques.

Radar 115 may include multiple radar sensing systems and devices to detect objects around the AV 100. In some instances, a radar system can be implemented at one or more of each of the four corners of the AV 100, on the front side of the AV 100, on the rear side of the AV 100, and on the left side and right side of the AV 100. Radar sensors may be implanted at other locations as well to collect data regarding objects within a short distance (e.g., 5 feet) or long distance (e.g., 200 feet). Lidar 120 can be used to detect objects in adjacent lanes, in front of and behind the AV 100, and other locations depending on the location of the lidar sensors. The radar and lidar sensors can be used to detect stationary and moving objects in adjacent lanes as well as in the current lane in front of and behind the AV 100.

Microphones 122 can be used to receive and process audio information. The audio information can include horns or other sounds emitted by other vehicles, utterances spoken by individuals and/or machines, and other audio of interest. The received audio information may be translated, parsed, and processed to identify text and context, and data processing system 125 can create actions to take based on the translated, parsed and processed data.

Additional sensors may be implemented with AV 100, including but not limited to ultrasound sensors, IR sensors, and other sensors.

Output mechanisms 124 may include one or more mechanisms that provide output from AV 100. The output mechanisms 124 may include one or more of external turn signals, a horn, lighting on the exterior of AV 100, LED display, or other display suitable for displaying text, video, and other visual content for communicating an intention, message, or other content. The output mechanism can be used to communicate an intention in response to determining an object's intention as part of an interactive scenario.

Data processing system 125 may include one or more processors, memory, and instructions stored in memory and executable by the one or more processors to perform the functionality described herein. In some instances, the data processing system 125 may include a planning module, control module, and drive by wire (DBW) module. The modules can communicate with each other to perform operations including by not limited to receive raw and processed data, perception data, identify lane lanes, determine and sample lines along which to navigate the AV, generate a decision for the AV, and generate commands to execute the generated decision.

Acceleration 130 may receive commands from the data processing system to accelerate. Acceleration 130 can be implemented as one or more mechanisms to apply acceleration to the propulsion system 150. Steering module 135 controls the steering of the AV 100 and may receive commands from data processing system 135 to steer the AV 100. Brake system 140 may handle braking applied to the wheels of the AV 100 and may receive commands from data processing system 125. Battery system 145 may include a battery, charging control, battery management system, and other modules and components related to a battery system of the AV 100. Propulsion system 150 may manage and control propulsion of the AV 100 and may include components of a combustion engine, electric motor, drivetrain, and other components of a propulsion system utilizing an electric motor with or without a combustion engine.

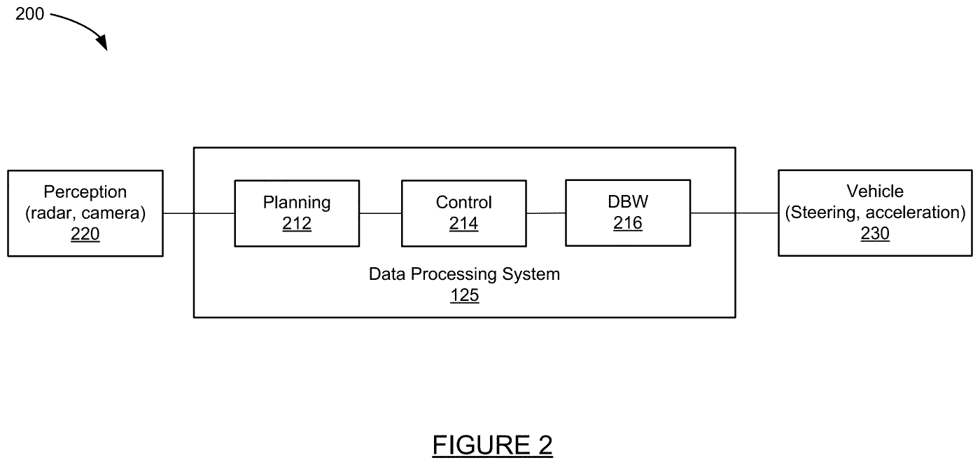

FIG. 2 is a block diagram 200 of a data processing system of an AV. The data processing system 125 may receive data and information from perception module 220. Perception module 220 can be in communication with a plurality of sensors installed in or on the AV 100. The sensors may include a radar, lidar, microphones, and camera elements, as well as logic for processing the sensor output. The perception module can identify objects of interest, lane lines object location, speed, and acceleration, and object gestures, if any, and provide the data to planning module 212.

Planning module 212 may receive and process data and information received from the perception module 220 to plan actions for the AV. The action planning may include adjusting a lateral position of an AV navigating a lane, accelerating within a current lane, braking within a current lane, and other actions. Planning module 212 may generate samples of trajectories between two lines or points, analyze and select the best trajectory, and provide the best trajectory for navigating from one point to another point for control module 214

Control module 214 may receive information from the planning module 212, such as a selected trajectory within a lane, an acceleration or brake action, or another action. Control module 214 may generate commands to execute the action, such as for example to navigate the selected trajectory. The commands may include instructions for performing the action, such as for example accelerating, braking, and turning the AV to effectuate navigation along the selected trajectory, activating a turn signal, displaying a message, and so forth.

Drive-by-wire (DBW) module 216 may receive commands from control module 214 and actuate navigation components and output mechanisms of the AV based on the commands. In particular, DBW module 216 may control the accelerator, steering wheel, brakes, and output mechanisms such as turn signals, lights, displays and/or panels, speakers.

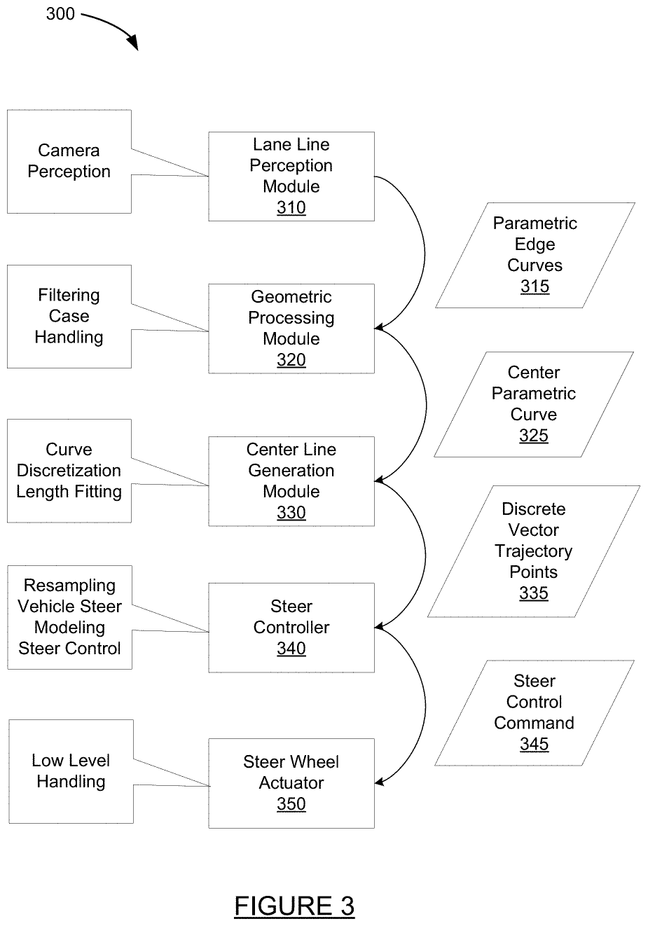

FIG. 3 is a block diagram of system logic 300 for navigating an AV in a current lane, according to an example embodiment. The block diagram shows system logic 300 implemented in an AV, for example as modules, implemented in memory and executed by one or more processors, which can be implemented as part of a perception module, planning module, control module, and DBW module of the AV 100 described above with reference to FIG. 1. The system logic 300 includes a lane line perception module 310, a geometric processing module 320, a center line generation module 330, a steer controller 340, and a steer wheel actuator 450.

The lane line perception module 310 may receive camera perception data (and other sensor data, optionally) that includes a lane line data. The lane line data may include images of lane lines and locations, such as for example coordinates, for the lane lines. The image of the road may include visual indicators associated with lane boundaries, for example an image of markings painted on the pavement of the road such as solid single lines, solid double lines, broken single lines, double lines broken on one side, reversable lane lines, and so forth.

In some instances, object data for objects other than lane lines may be received from the perception module. The object data can include vehicle objects, pedestrian objects, bicycle objects, and other objects. For a vehicle object, the sensor data may include one or more of a vehicle location, speed, and acceleration.

In some embodiments, the lane line perception module 310 may be included all or in part within perception module 220 and planning module 212. The lane line perception module 310 may generate, based on the lane line data, parametric edge curves 315 that are fitted to the location and path of each lane line detected from sensor data (e.g., from camera image data) in the current lane in which the AV is traveling. Hence, the parametric edge curves 315 may include a first parametric edge curve to match a first lane line (e.g., left lane line) and a second parametric edge curve to match a second lane line (e.g., right lane line).

The first parametric curve can be defined as y=f₁(x) and the second parametric curve can be defined as y=f₂(x), wherein both functions are defined within an XY coordinate system. The XY coordinate system can be an “ego-vehicle” coordinate system, wherein the X-axis is directed along a vector of the current trajectory of the AV and the Y-axis is orthogonal to the vector of the trajectory of the AV, wherein the AV is at the origin of the coordinate system.

In some instances, the analytical form of the first parametric curve y=f₁(x) and the second parametric curve y=f₂(x) can be the same or different depending on a shape of the location of the first lane line and shape of location of the second lane line. In some instances, the first parametric curve can be fitted with a third order parametric curve y=a₁x³+a₂x²+a₃x+a₀. Similarly, the second parametric curve can be fitted with a third order parametric curve y=b₁x³+b₂x²+b₃x+b₀. The coefficients a₃, a₂, a₁, a₀ can be found by fitting the curve y=a₁x³+a₂x²+a₃x+a₀ to the detected location of the first lane line. The coefficients b₃, b₂, b₁, b₀ can be determine by fitting the curve y=b₁x³+b₂x²+b₃x+b₀ first to the detected location of the second lane line.

The first parametric curve and the second parametric curve, including the function coefficients, can be provided to the geometric processing module 320. After receiving the parametric curve and coefficient values, the geometric processing module 320 may generate a center parametric curve 325 based on the first parametric curve and the second parametric curve. The center parametric curve 325 can be represented as y=f_{c}(x) in the same coordinates system as the first parametric curve and the second parametric curve. The analytical form of the center parametric curve 325 can be the same as or different from the analytical form of the first parametric curve or the second parametric curve. In some embodiments, the center parametric curve can be represented as y=c₁x³+c₂x²+c₃x+c. The center parametric curve 325 may include filtering the first parametric curve and/or the second parametric curve. For example, the generation of the center parametric curve 325 may include determining or selecting an analytical form of the center parametric curve 325 based on geometrical shape and curvature of the first parametric curve and geometrical shape and curvature of the second parametric curve. The geometric processing module 320 may provide the analytical form of the center parametric curve 325 and parameters of analytical form of the center parametrical curve to the center line generation module 330.

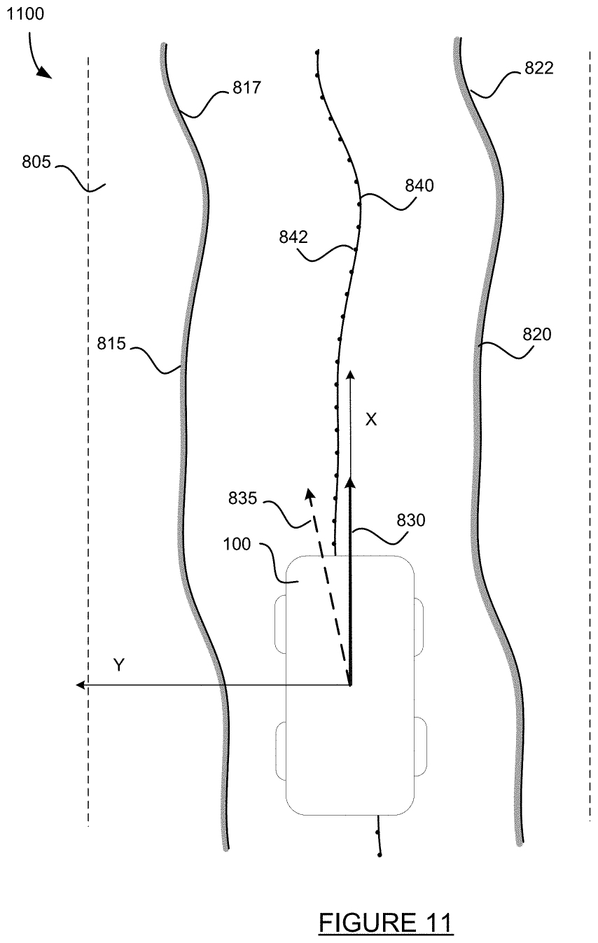

The line generation module 330 may generate, based on the center parametric curve 325, a discrete vector of trajectory points 335. The trajectory points 335 can be located along the center parametric curve (see points 842 of FIG. 11). Generation of the discrete vector of the trajectory points may include discretization of the center parametric curve 325. Prior to the discretization of the center parametric curve 325, the center line generation module 330 may determine a starting point on the center parametric curve and a length of a part of the center parametric curve to be discretized. The determination of the length of the part of the center parametric curve can be based on current AV speed, current AV acceleration, desired number of points, desired time in advance for which points should be generated, desired distance for which points should be generated, or other factors. For example, the determination of the length of the part of the center parametric curve can be based on number of the trajectory points 335 in the discrete vector. In certain embodiments, the number of the trajectory points in the discrete vector can be pre-fixed. For example, the number of the trajectory points can be set to 40, 50, 60, 80, 100, or some other number. In some instances, the faster the speed or acceleration of the AV, the longer the length of the center parametric curve that will be discretized. For a higher current speed of the AV, the trajectory points 335 can be located further apart along the center parametric curve; for lower speeds of the AV, the trajectory points may be located closer together. It should be noted that the length of the part of the center parametric curve corresponding to a zero speed of the AV (when the AV stops) can be selected to be non-zero minimal value. The trajectory points 335 can be represented in the same coordinate system as the first parametric curve, the second parametric curve, and the center parametric curve 325. The discrete vector of the trajectory points 335 can be provided to the steer controller 340.

In some embodiments, a steer controller 340 may generate, based on the discrete vector of the trajectory points 335, one or more steer control commands 345. The steer control commands may include an action to navigate the AV along the trajectory points 335. An action may include a change of speed of the AV, a change of an acceleration of the AV, a change of driving direction, and a combination thereof to keep the AV along the trajectory points, and thereby keep the AV in the driving lane.

The logic of modules 310-350 may generate parametric curves from lane boundaries, a center parametric curve, discrete trajectory points, steer control commands, and acceleration and deceleration commands during each computing cycle so that actions and control commands are continuously being generated and/or the navigation path is continuously analyzed based on updated perception data. The system 300 can continuously collect data, process data, and generate actions to navigate the AV based on the processed data in real-time. Hence, the generation of the action to navigate the AV can include resampling the trajectory points 335 and feeding the resampled trajectory to the steer control model 340. The steer control model may be configured to estimate an angle for steering the wheels of the AV and a speed for steering the wheels of the AV to generate the steer control command 345. The steer control command 345 can be provided to the steer wheel actuator 450. The steer wheel actuator 450 can perform actual mechanical steering of wheel of the AV by an angle and speed determined in the steer control command 345.

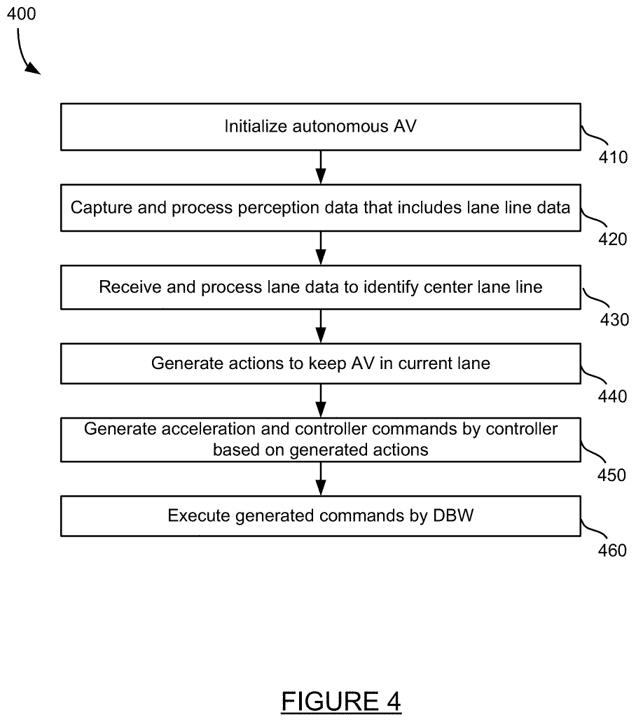

FIG. 4 is a flow chart illustrating a method 400 for keeping an AV in a driving lane, in accordance with an example embodiment. First, an AV is initialized at step 410. Initializing the AV may include starting the AV, performing an initial system check, calibrating the AV to the current ambient temperature and weather, loading passenger and/or other preferences and settings, and calibrating any systems as needed at startup.

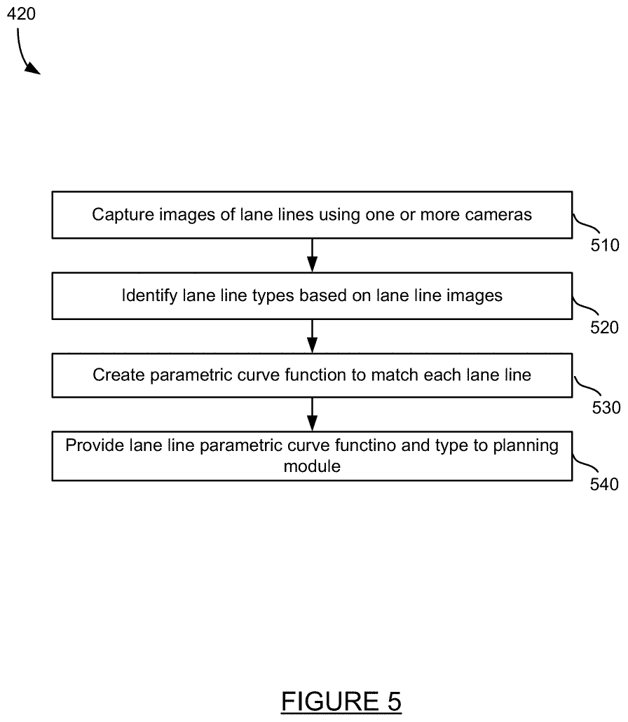

Next, data can be received from one or more AV sensors and processed by a perception module at step 420. The data may include image data received from one or more cameras, data received from one or more sensors such as radar, lidar, ultrasound, and UV sensors, audio data from microphones, and other data. The received data can be processed to detect the lane line data in a road currently traveled by the AV. In some instances, lane lines that correspond to the boundaries of the current lane can be determined from the captured perception data, for example a left lane and a right lane. Step 420 is described in more detail below with reference to FIG. 5.

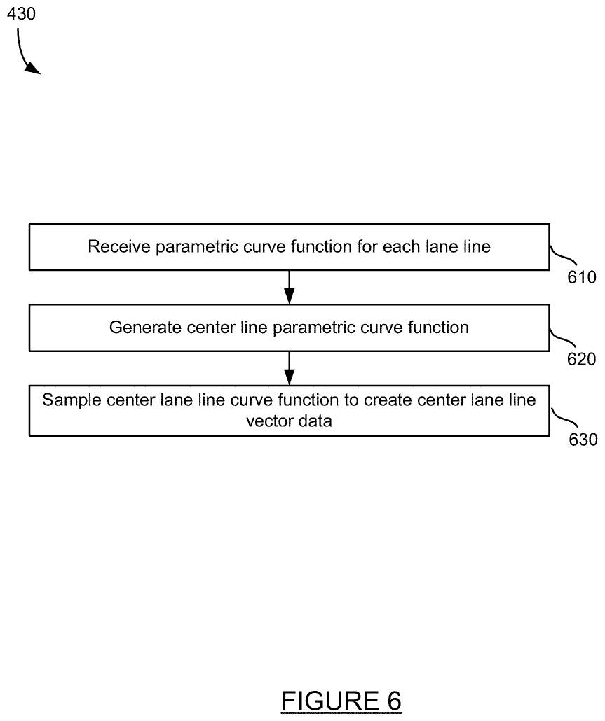

A center lane line is identified based on the boundary lane lines at step 430. The lane line lines that form the boundary of the currently traveled line and detected as part of step 420 can be used to generate the center lane line. Step 430 of the method 400 is described in more detail below with reference to FIG. 6.

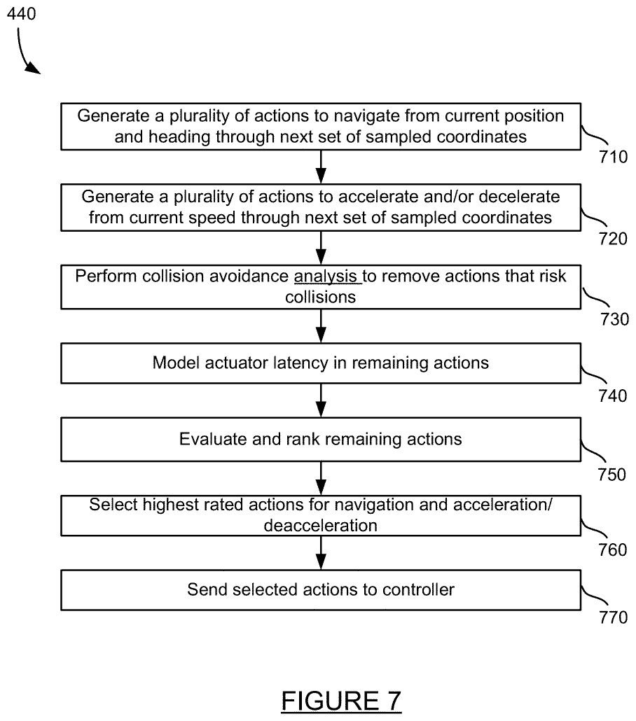

One or more actions to keep the AV in the current lane are generated based on the center lane line at step 440. The actions may include determining vehicle speed, navigation between points along a center lane line, performing a collision avoidance analysis, and other steps. Operation 440 of the method 400 is described in more detail below with reference to FIG. 7.

Acceleration and controller commands can be generated by a controller based on the generated actions to navigate the AV at step 450. The acceleration commands may indicate when the AV should accelerate, stay at the same speed, or slow down, as well as when the AV should apply its brakes. The controller commands can also indicate to what degree the wheels should turn in order to navigate along the center lane line.

The commands to navigate the AV are executed at step 670. Execution may include having the DBW module 216 to actuate the commands through one or more of turn signals, lights, a panel a display, as well as acceleration, braking, turning, and any other communication or physical AV controls.

FIG. 5 illustrates a method for generating lane parametric curves. The method of FIG. 5 provides additional details for step 420 of the method 400 of FIG. 4. In some instances, generating lane parametric curves is performed as part of capturing and processing of perception data. Accordingly, the method of FIG. 5 can be carried out by a perception module of the AV. First, images of lane lines are captured by a perception module of the AV using one or more cameras at step 510. The lane lines may be captured from a forward-facing camera, side camera, rear facing camera, and/or other camera that can be found on an AV.

Next, types of lane lines can be identified from the images of the lane lines at step 520. The lane line type can be identified using an image processing algorithm, neural network, image processing AI, and/or other method. The types of line may include a single solid line, a broken single line, a double solid line, a partial broken double line, and so forth.

Parametric curve functions to be matched to each lane line can be created at step 530. The parametric curves can be represented as functions y=fᵢ(x, p₁ⁱ, p₂ⁱ, . . . , pₙⁱ), wherein the x and y are coordinates of a system of coordinates associated with the AV, p₁ⁱ, p₂ⁱ, . . . , pₙⁱ are parameters to be optimized to fit the functions y=fᵢ(x, p₁ⁱ, p₂ⁱ, . . . , pₙⁱ) to the location of the lane lines in the one or more images image, and i is an index of a left line or a right line of the driving lane. In some embodiments, the x coordinate is along a vector of speed of the AV and the y coordinate is orthogonal to the vector of the speed of the AV. In some embodiments, the functions y=fᵢ(x, p₁ⁱ, p₂ⁱ, . . . , pₙⁱ) can be third order polynomials of x.

Once the parametric curve functions are generated, the lane line parametric curve functions and the type of the lane can be provided to a planning module at step 540.

FIG. 6 is a method for generating center line vector data. The method of FIG. 6 provides additional details for step 430 of the method of FIG. 4. The method of FIG. 6 can be carried out by a planning module of the AV. First, parametric curve functions for each lane line are accessed at step 610. The parametric curves may include a first parametric curve matching the location and trajectory of a first lane line and a second parametric curve matching the location and trajectory of a second lane line. The first and second lane line can be the lane lines that form the lane in which the AV is currently traveling. The parametric curves can be represented as function y=fᵢ(x, p₁ⁱ, p₂ⁱ, . . . , pₙⁱ) as described above in detail with reference to FIG. 5.

A center line parametric curve function is generated at step 620. The center line parametric curve function can be generated based on the parametric curve functions for the lane lines. For example, the center line parametric curve can be determined as an average of the first parametric curve function and the second parametric curve function, such that the center line function is in the center of two parametric curve functions provided by the perception model. In some embodiments, the center line parametric curve can be found by filtering the parametric curve functions for the lane lines. In some embodiments, the analytical form of the center line parametric curve can be determined or selected based on a curvature of the parametric curves for lane lines. In certain embodiments, the analytical form of the center line parametric curve can differ from the analytical forms of the parametrical curves for lane lines.

The center lane line curve can be then sampled at step 630 to create center line vector data. The center line vector data may include coordinates of trajectory points along the center lane line curve. The number of the trajectory points can be pre-fixed or dynamically determined based, for example, on a current speed and acceleration of the AV. A length of a part of the center lane line curve to be discretized can be determined based on the current speed and the acceleration of the AV, a period of time, a distance, or some other parameter. In some instances, the length can be longer for a higher current speed and shorter for a lower speed. The trajectory points can be sampled sparser for a higher current speed of the AV. In some instances, the discrete vector points may be along the center lane line at intervals of 10 feet, 20 feet, 30 feet, 50 feet or some other distance. In some instances, the discrete vector points may be along the center lane line such that the AV will reach each vector point every 0.1 seconds, 0.2 seconds, 0.5 second, 1 second, or some other time period.

FIG. 7 illustrates a method for generating actions to keep the AV in a current driving lane. The method of FIG. 7 provides additional details for step 440 of the method of FIG. 4. The method of FIG. 7 can be carried out by a planning module of the AV.

First, a plurality of actions to navigate from the current position and heading through next set of sampled coordinates are generated at step 710. The sampled coordinates represent a vector of trajectory points along a center lane line curve as described by a function. The generated action may be indicative on an angle at which a wheel of the AV is to be steered at the current position and one or more subsequent sampled locations.

Next, a plurality of actions to accelerate and/or decelerate from the current speed through the next set of sampled coordinates are generated at step 720. The actions to accelerate or decelerate may be based on user comfort and jerk preferences, speed limit for the current road, the activity of other traffic on the road, and other factors. A collision avoidance analysis can be performed at step 730. In some instances, actions that risk collisions with other vehicles, either immediately or in the near future (e.g., 10 seconds), can be removed from the plurality of the actions to accelerate or decelerate as well as steering wheel navigation actions.

An actuator latency can be modeled in remaining actions at step 740. In some instances, there can be a latency from the time an action is generated and the time at which a command is executed such that the acceleration, deceleration, or steering is physically carried out by an actuator. The actuator latency accounts for the latency between action generation and actuator action. As a result, the generated action is designed to be effective based on the latency. For example, if the latency between the generation of an action and the actuator action is 0.5 seconds, the actuator latency will be modeled to generate actions that will be performed 0.5 seconds from the time they actions are generated by the planning module.

The remaining actions of the plurality of actions generated at step 710 can be evaluated and ranked at step 750. A highest ranked action for navigation and acceleration or deacceleration can be selected at step 760. In some instances, an action may involve navigation from a first location to a second location, which can include acceleration and/or deceleration as well as actuating the steering of the AV. The selected actions can be sent to a controller of the AV at step 770.

The method steps of FIGS. 4-7 are provided in an exemplary order. It is intended that any of the steps can be performed in a different order, be split into multiple steps or combined with other steps, be performed serially or in parallel with other steps. Additionally, each method of FIGS. 4-7 can include additional or fewer steps than those illustrated. The methods of FIGS. 4-7 can each be performed by processing logic that may comprise hardware (e.g., decision making logic, dedicated logic, programmable logic, and microcode), software (such as software run on a general-purpose computer system or a dedicated machine), or a combination of both.

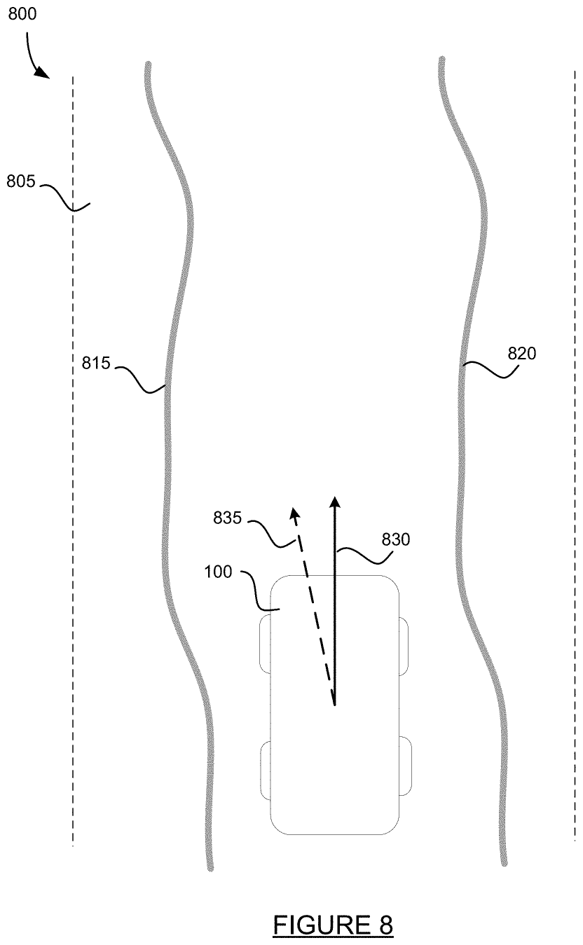

FIG. 8 illustrates an environment 800 within which a system and method for keeping an AV in a driving lane can be implemented, in accordance with some example embodiments. The environment 800 includes a part of road 805, a first lane line 815 and a second lane line 820 located road 805, and an AV 100. The AV 100 navigates within the lane between the first lane line 815 and the second lane line 820. Even though the first lane line 815 and the second lane line 820 shown in FIG. 8 are solid single lines, in other embodiments, at least one of the lane lines 815 or 820 can be a different lane marker, such as a broken single line, a solid double lines, a double line broken from one side, reversable lane line, and so forth. The lane lines 815 and 820 may curve in parallel or independently from each other.

The AV 100 is headed in a direction 830. The AV may receive perception data, process the data, identify and match functions to the direction of the lane lines, and generate actions to navigate the AV within the lane lines. In the environment illustrated in FIG. 8, the actions may result in the AV being directed along direction 835 to stay substantially in the center of the lane defined by the lane lines 815 and 820.

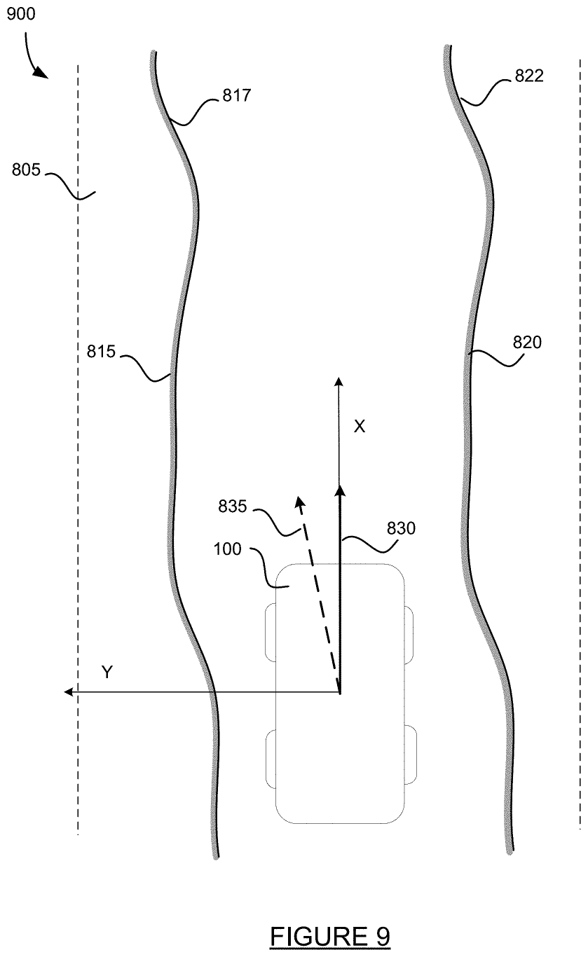

FIG. 9 illustrates an environment 900 within which a system and method for keeping an AV in a driving lane can be implemented, in accordance with some example embodiments. The environment 900 includes a part of road 805, a first lane line 815 and a second lane line 820 located on road 805, an AV 100, a direction 830 in which the AV 100 is headed and a direction 835 in which the AV 100 can navigate to stay substantially in the center of the lane limited by the lane lines 815 and 820.

The environment 900 includes a first parametric curve 817 and a second parametric curve 822. The first parametric curve 817 and the second parametric curve 822 can be determined by a perception module of AV 100. The first parametric curve 817 and the second parametric curve 822 represent parametric functions in the XY coordinate system having an origin at the AV. The first parametric curve 817 is fit to match the location of the first lane line 815 and the second parametric curve 822 is fit to match the location of the second lane line 820. The X coordinate can be selected to be along a heading or current speed of the AV 100 and the Y coordinate can orthogonal to X.

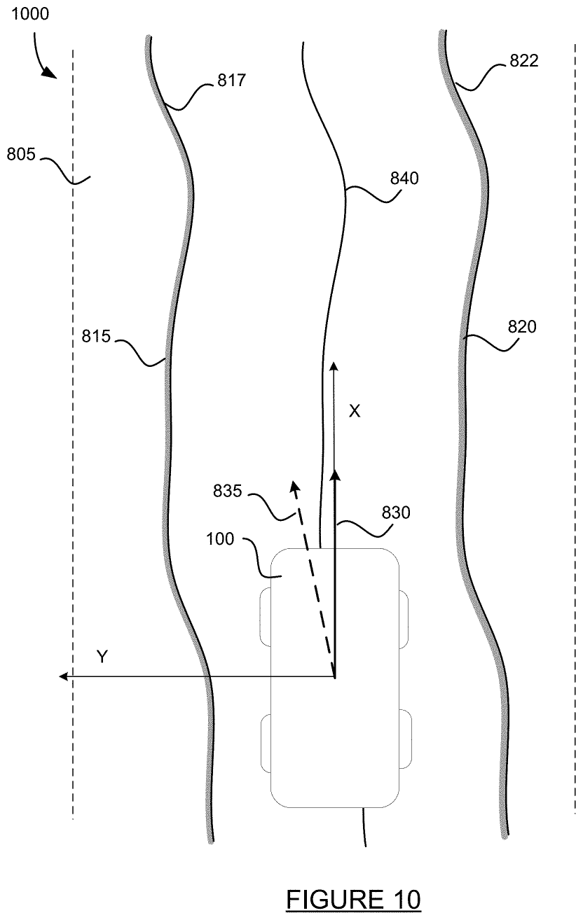

FIG. 10 illustrates an environment 1000 within which a system and method for keeping an AV in a driving lane can be implemented, in accordance with some example embodiments. The environment 1000 includes the elements as described in FIG. 9 as well as a center parametric curve 840. The center parametric curve 840 can be determined by a planning module of the AV based on the first parametric curve 817 and the second parametric curve 822. The center parametric curve 840 may be generated as the center between the first lane line 815 and the second lane line 820.

FIG. 11 illustrates an environment 1100 within which a system and method for keeping an AV in a driving lane can be implemented, in accordance with some example embodiments. The environment 1100 includes the elements as described in FIG. 10.

The environment 1100 also includes a discrete vector of trajectory points 842. The trajectory points can be generated by a control module of AV from the center parametric curve 840. The trajectory points 843 are located along the center parametric curve 840. The length of a part of the center parametric curve to be sampled can depend, for example, on current speed of the AV, time intervals, distance, and/or other factors. The trajectory points can be used by the control module to generate actions to navigate and accelerate or deaccelerate the AV along the center parametric curve. The actions can be further provided to a wheel steering controller of the AV.

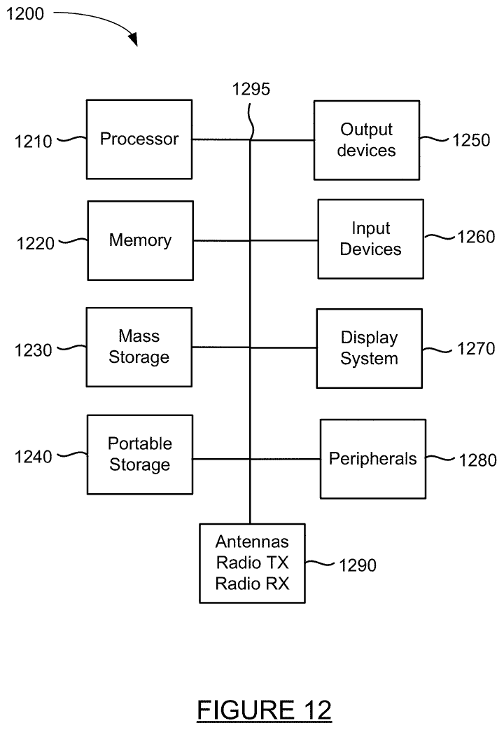

FIG. 12 is a block diagram of a computing environment for implementing a system for keeping AV in lane. System 1200 of FIG. 12 can be implemented in the contexts of a machine that implements an active interaction module of an AV. The computing system 1200 of FIG. 12 includes one or more processors 1210 and memory 1220. Main memory 1220 stores, in part, instructions, and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components can be connected through one or more data transport means. For example, processor unit 1210 and main memory 1220 can be connected via a local microprocessor bus, and the mass storage device 1230, peripheral device(s) 1280, portable storage device 1240, and display system 1270 can be connected via one or more input/output (I/O) buses.

Mass storage device 1230, which can be implemented with a magnetic disk drive, an optical disk drive, a flash drive, or other device, is a non-volatile storage device for storing data and instructions for use by processor unit 1210. Mass storage device 1230 can store the system software for implementing embodiments of the present technology for purposes of loading that software into main memory 1220.

Portable storage device 1240 operates in conjunction with a portable non-volatile storage medium, such as a flash drive, USB drive, memory card or stick, or other portable or removable memory, to input and output data and code to and from the computer system 1200 of FIG. 12. The system software for implementing embodiments of the present technology can be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touch-screen, accelerometer, a wireless device connected via radio frequency, a motion sensing device, and other input devices. Additionally, the system 1200 as shown in FIG. 12 includes output devices 1250. Examples of suitable output devices include speakers, printers, network interfaces, speakers, and monitors.

Display system 1270 may include a liquid crystal display (LCD) or other suitable display devices. Display system 1270 receives textual and graphical information and processes the information for output to the display device. Display system 1270 may also receive input as a touch-screen.

Peripherals 1280 may include any type of computer support device to add additional functionality to the computer system. For example, peripheral device(s) 1280 may include a modem or a router, printer, and other devices.

The system of 1200 may also include, in some implementations, antennas, radio transmitters and radio receivers 1290. The antennas and radios can be implemented in devices such as smartphones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1200 of FIG. 12 are those typically found in computer systems that can be suitable for use with embodiments of the present invention and are intended to represent a broad category of such computer components that are well known in the art. Thus, the computer system 1200 of FIG. 12 can be a personal computer, handheld computing device, smartphone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

The detailed description of embodiments described herein includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

What is claimed is:

1. A system for keeping an autonomous vehicle in a driving lane, the system comprising:
a data processing system comprising one or more processors, a memory, planning module, and a control module, the data processing system to:
generate a first parametric curve to match a first lane line and a second parametric curve to match a second lane line, the first lane line and the second lane line representing boundaries of a lane;
determine, based on the first parametric curve and the second parametric curve, a center parametric curve that extends in a center between the first lane line and the second lane line;
generate, based on the center parametric curve, a discrete vector of trajectory points, wherein the trajectory points are along the center parametric curve; and
generate, based on the discrete vector of the trajectory points, at least one action to navigate the autonomous vehicle along a set of the trajectory points.

2. The system of claim 1, the data processing system to receive lane line data for the first lane line and the second lane line, the lane line data including sensor data received from at least one sensor, the at least one sensor including a camera.

3. The system of claim 2, wherein the data processing system to:
determine the location of the first lane line from the lane line data;
determine the location of the second lane line from the lane line data;
fit the first parametric curve to match the location of the first lane line; and
fit the second parametric curve to match the location of the second lane line.

4. The system of claim 1, wherein:
the first parametric curve includes a first cubic curve; and
the second parametric curve includes a second cubic curve.

5. The system of claim 1, wherein the at least one of the first parametric curve and the second parametric curves is a third order parametric curve.

6. The system of claim 1, wherein the determining the discrete vector of the trajectory points includes determining a length of a part of the center parametric curve to be discretized.

7. The system of claim 6, wherein the determination of the length is based on at least one of a current speed and a current acceleration of the autonomous vehicle.

8. The system of claim 1, wherein a number of the trajectory points in the discrete vector is pre-fixed.

9. The system of claim 1, wherein the at least one action includes at least one of a change in a heading for the autonomous vehicle by an angle from the driving direction and a change of a current speed of the autonomous vehicle.

10. A method for keeping an autonomous vehicle in a driving lane, the method comprising:
generating, by a data processing system, a first parametric curve to match a first lane line and a second parametric curve to match a second lane line, the first lane line and the second lane line representing boundaries of a lane;
determining, by the data processing system and based on the first parametric curve and the second parametric curve, a center parametric curve that extends in center between the first lane line and the second lane line;
generating, by the data processing system and based on the center parametric curve, a discrete vector of trajectory points, wherein the trajectory points are along the center parametric curve; and
generating, by the data processing system and based on the discrete vector of the trajectory points, at least one action to navigate the autonomous vehicle along a set of the trajectory points.

11. The method of claim 10, the data processing system to receive lane line data for the first lane line and the second lane line, the lane line data including sensor data received from at least one sensor, the at least one sensor including a camera.

12. The method of claim 10, wherein the data processing system to:
determine the location of the first lane line from the lane line data;
determine the location of the second lane line from the lane line data;
fit the first parametric curve to match the location of the first lane line; and
fit the second parametric curve to match the location of the second lane line.

13. The method of claim 10, wherein:
the first parametric curve includes a first cubic curve; and
the second parametric curve includes a second cubic curve.

14. The method of claim 10, wherein the at least one of the first parametric curve and the second parametric curves is a third order parametric curve.

15. The method of claim 10, wherein the determining the discrete vector of the trajectory points includes determining a length of a part of the center parametric curve to be discretized.

16. The system of claim 15, wherein the determination of the length is based on at least one of a current speed and a current acceleration of the autonomous vehicle.

17. The system of claim 12, wherein a number of the trajectory points in the discrete vector is pre-fixed.

18. The system of claim 12, wherein the at least one action includes at least one of a change in heading for the autonomous vehicle by an angle from the driving direction and a change of a current speed of the autonomous vehicle.

19. A non-transitory computer readable storage medium having embodied thereon a program, the program being executable by a processor to perform a method for lane keep control of an autonomous vehicle, the method comprising:
generating a first parametric curve to match a first lane line and generate a second parametric curve to match a second lane line, the first lane line and the second lane line representing boundaries of a lane;
determining, based on the first parametric curve and the second parametric curve, a center parametric curve that extends in center between the first lane line and the second lane line;
generating, based on the center parametric curve, a discrete vector of trajectory points, wherein the trajectory points are along the center parametric curve; and
generating, based on the discrete vector of the trajectory points, at least one action to navigate the autonomous vehicle along a set of the trajectory points.

20. The non-transitory computer readable storage medium of claim 19, wherein the at least one action includes at least one of a change in a heading for the autonomous vehicle by an angle from the driving direction and a change of a current speed of the autonomous vehicle.
